(19) United States
(12) Patent Application Publication
(10) Pub. No.: US 2006/0097846 A1
(43) Pub. Date: May 11, 2006

(54) Use of an information support for climatic and environmental improvement

(76) Inventor: Aloys Wobben, Aurich (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/526,739

(22) PCT Filed: Sep. 5, 2003
(86) PCT No.: PCT/EP03/09857

§ 371 Date: Sep. 12, 2005

(30) Foreign Application Priority Data
Sep. 5, 2002 (DE) 102 41 535.8
Aug. 12, 2003 (DE) 103 37 320.9

(51) Int. Cl. H04Q 5/22

(52) U.S. Cl. 340/10.1

(57) ABSTRACT

Motor vehicles of all kinds with the most widely varying drives have long been known. Such motor vehicles usually burn for operation thereof fluid fossil fuels such as for example derivatives obtained from crude oil such as diesel, petrol and the like to which additives can also be added. The use of such fossil fuels in motor vehicles gives rise to a wide range of different pollutants such as for example carbon monoxide, nitrogen oxides, carbon dioxide, particulates and so forth. The object of the present invention is to reduce at least one pollutant component in the combustion of fossil fuels of all kinds, in which respect the technological complication and expenditure to be applied for that purpose is to be as slight as possible. Use of an information carrier of ENERCON type in a vehicle, wherein the information carrier is preferably mounted at a small spacing and/or over as large an area as possible and/or in contacting relationship on the engine block and/or fuel tank and/or fuel line and/or the air conditioning installation and/or another part in the interior of the vehicle.

Motor vehicles of all kinds with the most widely varying drives have long been known. Such motor vehicles usually burn for operation thereof fluid fossil fuels such as for example derivatives obtained from crude oil such as diesel, petrol and the like to which additives can also be added. The use of such fossil fuels in motor vehicles gives rise to a wide range of different pollutants such as for example carbon monoxide, nitrogen oxides, carbon dioxide, particulates and so forth.

The problems which arise with the combustion of fossil fuels, whether they are in a fluid condition, such as the above-mentioned liquid fuels, or also in a gaseous condition, for example natural gas, town gas and so forth are widely known and do not need to be particularly mentioned at this juncture.

To a not inconsiderable extent it is precisely the combustion of fossil fuels that is also considered to be responsible for global warming or climatic change.

The object of the present invention is to reduce at least one pollutant component in the combustion of fossil fuels of all kinds, in which respect the technological complication and expenditure to be applied for that purpose is to be as slight as possible. In addition the invention seeks to provide that the emission of another pollutant is not increased due to the reduction in one pollutant. In addition the invention seeks to make it possible that the reduction in the pollutant is also effected without intervention in the combustion assemblies for the fossil fuels such as vehicle engines, the management thereof or fuel combustion assemblies in power stations.

The invention attains that object with the use of an information carrier of ENERCON type in the most widely varying kinds in a vehicle, in relation to combustion assemblies (for example combustion chambers) or in the storage devices for fossil fuels or the conduits thereof.

An information carrier of ENERCON type is a medium, preferably a disc-shaped medium, for example a Compact disc or the like, which was previously programmed. Programming is effected by a procedure whereby the information carrier, that is to say for example the preferably disc-shaped medium, is brought into direct contact with or closely approaches a mixture of substances substantially comprising the individual constituents quartz sand, peat and glass, and the information carrier remains in the immediate proximity of or in direct contact with the mixture of substances for some time, that is to say some minutes to some hours, days or weeks. The programming as such can also be altered by a procedure whereby the composition of the mixture of substances relative to each other is altered, for example 30% quartz sand, 40% peat, 30% glass, and all conceivable deviations therefrom.

An information carrier of ENERCON type can be obtained from ENERCON, Dreekamp 5, 26605 Aurich. This substantially involves a substantially disc-shaped information carrier, for example a Compact disc or a mini-CD, which is programmed by ENERCON.

If now that information carrier of ENERCON type is fitted to the drive of a vehicle, for example a private motor car, a drastic reduction in the pollutants usually caused in operation of the vehicle already occurs after a short time.

To demonstrate the mode of operation of the invention the applicant obtained two identical vehicles and fitted one thereof with the information carrier of ENERCON type on the engine block.

The measurements shown in Tables 1 and 2 from TÜV Nord, Hanover (TÜV=German organisation for testing safety of technical installations, machinery and motor vehicles) demonstrate that, in the vehicle provided with the information carrier of ENERCON type—Table 2—it was possible to measure an in part drastic reduction in various kinds of pollutants.

At the TÜV Nord, Hanover, which, in carrying out the measurements, had no knowledge of what measures had been implemented with the second vehicle, it was not possible to explain how such a drastic reduction in the various kinds of pollutants was to be achieved.

As can be seen from Tables 1 and 2 both vehicles were tested under identical conditions. The identical fuel was used in both vehicles.

When an information carrier of ENERCON type is mounted to the engine block of a private motor car drive, for example being glued thereon, it can also be established that the overall internal climate in the passenger compartment can be improved. That effect is still further reinforced if an information carrier of ENERCON type is mounted directly to the refrigerating unit or another part of the air conditioning installation or is mounted where the air which is blown into the passenger compartment passes therethrough.

A consequence of using the individual information carriers of ENERCON type in relation to the internal climate of a passenger compartment is also that an equal sensation of temperature is to be achieved in the interior of the passenger compartment if after fitting the information carrier of ENERCON type the air conditioning installation was set by 1° to 2° higher than previously. The internal climate in the passenger compartment clearly perceptibly improved and the driver had the feeling of breathing markedly fresher and cleaner air than previously.

A reduction in at least one kind of pollutant, preferably the most widely varying kinds of pollutants, can also be achieved if the information carrier of ENERCON type is mounted directly to the fuel tank and/or fuel line of the vehicle.

An investigation regarding the physical explanation as to how the information carrier of ENERCON type acts on the vehicle or the parts to which the information carrier is mounted could not yet be entirely concluded. Initial investigations show however that the information carrier of ENERCON type evidently imparts a change in essence to the assembly or material to which it is fitted, in which respect the information carrier presumably only initiates, that is to say starts off, that change in essence, and then the assembly to which the information carrier of ENERCON type is fitted automatically implements the change in essence.

If the very low level of complication and expenditure which the present invention involves is considered, it is more than astonishing that in part entirely drastic reductions in kinds of pollutant are to be achieved.

As can be seen from the certificates from TÜV Nord, Hanover, in particular Table 2, in the case of the vehicle provided with the information carrier of ENERCON type on the engine block a reduction in the kinds of pollutant such as HCc modal of almost 30% was achieved, the carbon monoxide (CO) content fell by more than 15%, the nitrogen oxide (Nox) content fell by almost 10%, the carbon dioxide (CO2) content fell by almost 10%, the pollutant values for HCc plus NOx fell by more than 10%, the consumption during the test fell by almost 10% and the emission of particulates fell by more than 70%.

The above-described invention can not only be already implemented in the case of new vehicles at the factory but it can also be retrofitted after delivery of the motor vehicle.

There is no need here for the specific statement that the information carrier of ENERCON type can be fitted in very many different ways to fuel storage arrangements, fuel conduits, fuel control systems and the like in any kind of power stations. It is only when the information carrier of ENERCON type is mounted at a spacing relative to the above-mentioned devices and/or over as large an area as possible on the above-mentioned devices and/or in contacting relationship with the above-mentioned devices, that it is possible to establish by measurement of the exhaust gases that a reduction in the pollutants occurs.

It is also possible for the information carriers of ENERCON type to be fitted to water conduits, in particular water pipes or other water duct arrangements in order to impress the information specific to the information carrier on the fluid flowing therethrough. That is appropriate in particular in the case of hydroelectric power stations, but it is known that, for various reasons, the water downstream of the hydroelectric power station allows a markedly lesser degree of growth of flora and fauna than above the power station.

It is also possible for buildings, parts of buildings, for example houses or shops and offices in factories to be provided with the information carrier of ENERCON type. That can be effected for example in such a way that the information carrier of ENERCON type is fitted to the walls within a room. Fitting it in a room has the effect that the room climate is markedly improved.

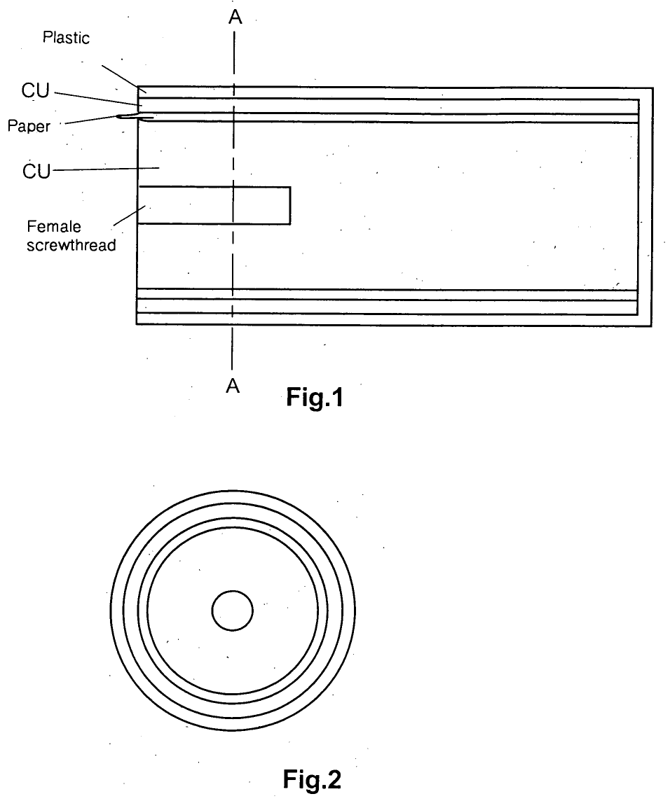

An alternative configuration of the information carrier in relation to a disc-shaped configuration is that it is of a cylindrical configuration (FIG. 1).

In that case the information carrier is of a multi-layer structure, more specifically firstly comprising a metal core and a paper layer which surrounds the metal core and which in turn is surrounded by a copper layer (metal layer) which in turn is again surrounded by a plastic casing.

The inner metal core preferably has a female screwthread and can thus be screwed to an engine block or easily fitted in an inverter station or to another piece of technical equipment if a suitable screw is present there, which fits the female screwthread.

The structure of the cylindrical information carrier is illustrated in accompanying FIGS. 1 and 2.

Preferably an information carrier is used per 50 kW of vehicle power and an information carrier is also used per 100 to 300 kW converter power.

If in the present application mention is made of the fact that the cylindrical body of the information carrier is provided with a female screwthread, it will be appreciated that any other fixing option is also afforded, thus for example a screw mounted thereto and having a male screwthread or other ways of fixing it, with which the information carrier is in direct contact with the piece of equipment which is to be informed.

If the information carrier which ultimately also has the function of an environmental catalyst is disposed in a control cabinet, for example the control cabinet of a wind power installation or in a converter (for converting current), it is advantageous if the information carrier of ENERCON type is installed together with a sine wave generator, in which case the information carrier is fitted in series circuit or in parallel circuit with respect to the sine wave generator.

In the case of a power cabinet of a wind power installation the information carrier can be mounted for example on the base plate in the power cabinet and can connect together for example an output and an input of the sine wave generator. If there are a plurality of power cabinets, then the individual information carriers of ENERCON type can also be connected in series, the connection being made in particular by a mounting board in the power cabinet.

The easily demonstrable function of the information carrier provides that a considerable improvement in the surroundings around the converter or power cabinet is afforded and consequently the wind power installation overall but also the power cabinets of the converters no longer have such a disrupting effect on the surrounding area.

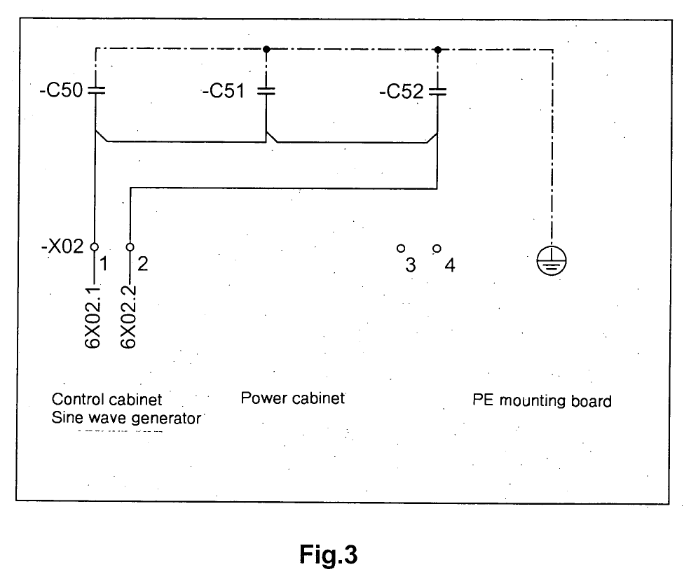

FIG. 3 shows the electrical equivalent circuit diagram of the information carrier of ENERCON type.

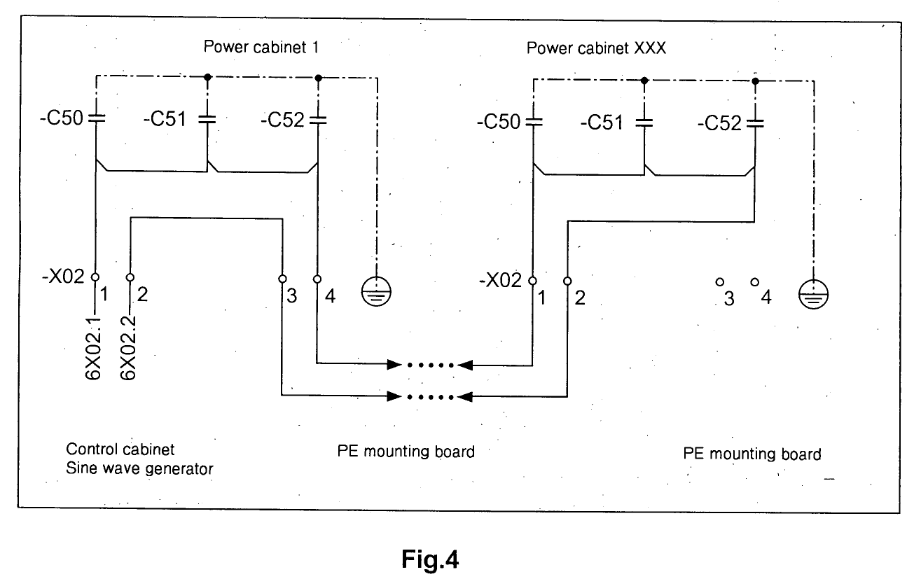

FIG. 4 shows the electrical equivalent circuit diagram of the information carrier of ENERCON type in an array of a plurality of power cabinets.

TABLE 1

| | |
|---|---|
| TÜV NORD STRASSENVERKEHR GMBH | TÜV |
| Vehicle system and traffic guidance | NORD |
| Exhaust gas checking | Strassenverkehr |

Hanover 14.08.2002

Test record RL 70/220/EEC in the version 98/69/EC

| | | | |
|---|---|---|---|
| Order No | 2063/02 | Fuel density | 0.837 kg/dm³ |
| Vehicle ID | WDB9036621R414193 | Distance | 363 km |
| Official No | WRM-0602 | Test weight | 2270 kg |
| Manufacturer | DC | Oscillation mass | 5000 lbs |
| Tyre size | 225/70 R 15 C | Coefficients (A =/B =/C =) | 9/0/619 |
| Tester | Mr Wohlrab | Specialist | Mr Braun |
| Driver | Mr Kozlik | | |
| Comments | | | |

| | | | |
|---|---|---|---|
| Oil temperature before test | 23° C. | Oil temperature after test | 100° C. |
| Air pressure | 1012.7 hPa | rel. humidity | 62% |
| Room temp. dry | 22.0° C. | abs. humidity | 10.23 g/kg air |
| Room temp. wet | 17.2° C. | humidity corr. | 0.985 |

| | Phase 1 | Phase 2 |
|---|---|---|
| Vmix | 134.38 m³ | 69.33 m³ |
| PDP speed | 1143 1/min | 1143 1/min |
| Test distance | 4094 m | 7005.2 m |
| Power mean value | 35.45 N | 331.08 N |
| Dilution factor | 24.766 | 10.597 |
| PTS volume | 412.2 dm³ | 211.3 dm³ |
| PTS removal temperature | 24.1° C. | 25.7° C. |

| | Exhaust gas 1 | Air 1 | Exhaust gas 2 | Air 2 |
|---|---|---|---|---|
| Bag values | vpm | vpm | vpm | vpm |
| HCc modal | 21.2 | 3.9 | 27.6 | 3.4 |
| CO | 89.5 | 2.0 | 117.1 | 0.2 |
| NOx | 33.0 | 0.6 | 67.7 | 0.5 |
| CO2 | 5300.0 | 500.0 | 12500.0 | 400.0 |

| Result | g/Phase 1 | g/km 1 | g/Phase 2 | g/km 2 |
|---|---|---|---|---|
| HCc modal | 1.452 | 0.355 | 1.051 | 0.150 |
| CO | 14.711 | 3.593 | 10.132 | 1.446 |
| NOx | 8.808 | 2.151 | 9.270 | 1.323 |
| CO2 | 1272.156 | 310.733 | 1652.725 | 235.929 |
| Particles | 1.327 | 0.324 | 1.525 | 8.991 |
| Consumption C | 1/100 km | 11.961 | | 8.991 |

Overall result

| | |
|---|---|
| HCc modal | 0.226 g/km |
| CO | 2.238 g/km |
| NOx | 1.629 g/km |
| CO2 | 263.521 g/km |
| HCc + NOx | 1.854 g/km |
| Consumption C | 10.0871/100 km |
| Particles | 0.257 g/km |

TABLE 2

| | |
|---|---|
| TÜV NORD STRASSENVERKEHR GMBH | TÜV |
| Vehicle system and traffic guidance | NORD |
| Exhaust gas checking | Strassenverkehr |

Hanover 14.08.2002

Test record RL 70/220/EEC in the version 98/69/EC

| | | | |
|---|---|---|---|
| Order No | 2058/02 | Fuel density | 0.837 kg/dm³ |
| Vehicle ID | WDB9036621R209687 | Distance | 37747 km |
| Official No | AUR-EC 97 | Test weight | 2270 kg |
| Manufacturer | DC | Oscillation mass | 5000 lbs |
| Tyre size | 225/70 R 15 | Coefficients (A =/B =/C =) | 9/0/619 |
| Tester | Mr Wohlrab | Specialist | Mr Leiber |
| Driver | Mr Kozlik | | |
| Comments | | | |

| | | | |
|---|---|---|---|
| Oil temperature before test | 20° C. | Oil temperature after test | 96° C. |
| Air pressure | 1012.7 hPa | rel. humidity | 61% |
| Room temp. dry | 21.9° C. | abs. humidity | 10.04 g/kg air |
| Room temp. wet | 17.0° C. | humidity corr. | 0.978 |

| | Phase 1 | Phase 2 |
|---|---|---|
| Vmix | 136.79 m³ | 68.4 m³ |
| PDP speed | 1143 1/min | 1143 1/min |
| Test distance | 4072.9 m | 6972.4 m |
| Power mean value | 34.69 N | 327.18 N |
| Dilution factor | 27.348 | 11.864 |
| PTS volume | 412.3 dm³ | 210.3 dm³ |
| PTS removal temperature | 23.8° C. | 25° C. |

| | Exhaust gas 1 | Air 1 | Exhaust gas 2 | Air 2 |
|---|---|---|---|---|
| Bag values | vpm | vpm | vpm | vpm |
| HCc modal | 16.7 | 3.7 | 18.6 | 3.0 |
| CO | 83.1 | 0.8 | 76.5 | 0.4 |
| NOx | 30.2 | 0.4 | 60.2 | 0.3 |
| CO2 | 4800.0 | 400.0 | 11200.0 | 400.0 |

| Result | g/Phase 1 | g/km 1 | g/Phase 2 | g/km 2 |
|---|---|---|---|---|
| HCc modal | 1.113 | 0.273 | 0.671 | 0.096 |
| CO | 14.077 | 3.456 | 6.509 | 0.934 |
| NOx | 8.180 | 2.008 | 8.214 | 1.178 |
| CO2 | 1186.014 | 291.196 | 1455.375 | 208.734 |
| Particles | 0.283 | 0.069 | 0.504 | 0.072 |
| Consumption C | 1/100 km | 11.207 | | 7.930 |

Overall result

| | | |
|---|---|---|
| HCc modal | 0.162 g/km | 71.7%-28.3% |
| CO | 1.864 g/km | 83.3%-16.7% |
| NOx | 1.484 g/km | 91%-9% |
| CO2 | 239.141 g/km | 90.9%-9% |
| HCc + NOx | 1.646 g/km | 88.8%-11.2% |
| Consumption C | 9.1391/100 km | 0.9%-9.4% |
| Particles | 0.071 g/km | 27%-72.3% |

1. Use of an information carrier of ENERCON type in a vehicle, wherein the information carrier is preferably mounted at a small spacing and/or over as large an area as possible and/or in contacting relationship on the engine block and/or fuel tank and/or fuel line and/or the air conditioning installation and/or another part in the interior of the vehicle.

2. Use according to claim 1 characterised in that the information carrier is a disc-shaped information carrier, for example a Compact disc (CD), mini CD, DVD or the like.

3. A vehicle comprising a drive characterised in that an information carrier of ENERCON type is mounted on the drive.

4. A vehicle comprising a drive and an air conditioning installation characterised in that an information carrier of ENERCON type is mounted to the air conditioning installation.

5. A vehicle comprising a drive and a chassis characterised in that an information carrier of ENERCON type is mounted to the chassis.

6. Use of an information carrier of ENERCON type on a transport medium such as for example a pipeline, a tube or the like for a liquid or gaseous medium, wherein the information carrier is mounted as a single unit or in multiple units preferably at a small spacing from and/or over as large an area as possible and/or in contacting relationship on the transport medium.

7. Use according to claim 6 characterised in that the liquid medium is a fossil fuel such as for example crude oil, diesel, petrol or the like, the combustion of which usually involves the emission of pollutants such as for example carbon dioxide, carbon monoxide and so forth.

8. Use of an information carrier of ENERCON type on an assembly (for example a firing assembly) which is capable of producing heating energy and/or motional energy by combustion of fossil fuels, for example liquid or gaseous fuels, wherein the information carrier is mounted at a small spacing and/or over as large an area as possible and/or in contacting relationship on the assembly and/or the feed conduits for the fuel to the drive assembly and/or on the fuel storage means.

9. Treatment of a liquid and/or gaseous or solid fuel with an information carrier of ENERCON type in which the fuel is exposed to the immediate proximity of the information carrier over a predetermined period of time.

10. Use of an information carrier of ENERCON type in a power cabinet and/or a converter device, in particular for a wind power installation.
